(19) United States
(12) Patent Application Publication
(10) Pub. No.: US 2014/0006645 A1
(43) Pub. Date: Jan. 2, 2014

(54) EMULATED KEYBOARD CONTROLLER AND EMBEDDED CONTROLLER INTERFACE VIA AN INTERCONNECT INTERFACE

(71) Applicant: Scott E. Matlock, Austin, TX (US)

(72) Inventor: Scott E. Matlock, Austin, TX (US)

(73) Assignee: ADVANCED MICRO DEVICES, INC., Sunnyvale, CA (US)

(21) Appl. No.: 13/540,003

(22) Filed: Jul. 2, 2012

(51) Int. Cl. G06F 3/00

(52) U.S. Cl. 710/5

(57) ABSTRACT

A method for emulating a command for communication with an input/output (I/O) port includes receiving the command from a host and redirecting the command to a microcontroller, whereby the microcontroller emulates the command by communicating with the I/O port.

### FIELD OF THE INVENTION

The present invention is generally directed to computer system design, and in particular, to using a generic microcontroller to emulate an interface to specific system components.

### BACKGROUND

Currently in the computer industry, an Embedded Controller (EC) is connected to a southbridge (SB) or Fusion Controller Hub (FCH) over a Low Pin Count (LPC) bus. But for tablets and smaller mobile devices, the LPC bus may not be available from the Accelerated Processing Unit (APU)/Central Processing Unit (CPU) or FCH/SB.

For mobile and tablet devices, a generic microcontroller may be connected to the CPU, APU, or FCH/SB via an interconnect such as a System Management Bus (SMBus) physical connection. A problem with this type of connection is that there is no way to map input/output (I/O) addresses into the SMBus space. This makes replacing a traditional EC with a generic microcontroller difficult if a platform designer wants to keep the existing power management standard (such as Advanced Configuration and Power Interface (ACPI)) defined interfaces valid. From a Basic Input/Output System (BIOS) and Operating System (OS) perspective, it is valuable to maintain the software interface across multiple products. The existing base of software for a given BIOS and OS could be used without any changes when a microcontroller connected via the SMBus replaces a traditional EC connected via LPC.

Connecting a generic microcontroller to an APU or FCH/SB via an SMBus typically requires an EC in the system to maintain compatibility to the ACPI defined interface for a keyboard controller (KBC) and the EC. If the platform designer replaces the EC and performs the EC functions on the generic microcontroller, the designer would also have to create a custom interface between the host software (the BIOS or OS) and the firmware running on the generic microcontroller. The chances of the custom interface being usable on other products would be unlikely, resulting in limited use of the custom interface.

### SUMMARY OF EMBODIMENTS

The solution described herein addresses the problem of connecting a generic microcontroller to an APU or FCH/SB via an interconnect, without having to create and define a proprietary interface not defined in a power management standard. In one implementation, the EC ACPI interface is emulated over a standard SMBus channel.

A method for emulating a command for communication with an input/output (I/O) port includes receiving the command from a host and redirecting the command to a microcontroller, whereby the microcontroller emulates the command by communicating with the I/O port.

A system for emulating a command sent by a host for communication with an I/O port includes a processor, a microcontroller, and a controller in communication with the processor and the microcontroller. The controller is configured to trap the command and redirect the command, whereby the command is emulated by communicating with the I/O port via the microcontroller.

A non-transitory computer-readable storage medium storing a representation of a circuit, the computer-readable representation including logic to emulate a command sent by a host for communication with an I/O port, the logic including a receiving code segment and a redirecting code segment. The receiving code segment receives the command from the host. The redirecting code segment redirects the command, so that the command is emulated by communicating with the I/O port via a microcontroller.

A hardware section for emulating a command for communication with an input/output (I/O) port, the hardware section configured to receive the command from a host, trap the command, and redirect the command, whereby the hardware section emulates the command by communicating with the I/O port via a microcontroller.

### BRIEF DESCRIPTION OF THE DRAWINGS

A more detailed understanding may be had from the following description, given by way of example in conjunction with the accompanying drawings, wherein:

FIG. 1 is a block diagram of an example device in which one or more disclosed embodiments may be implemented;

FIG. 2A is a block diagram of a CPU-based system using an LPC bus;

FIG. 2B is a block diagram of an APU-based system using an LPC bus;

FIG. 3A is a block diagram of a CPU-based system using an SMBus;

FIG. 3B is a block diagram of an APU-based system using an SMBus;

FIG. 3C is a block diagram of an alternate APU-based system using an SMBus;

FIG. 4 is a flowchart of a method for emulating a write command;

FIG. 5 is a flow diagram for emulating a write command;

FIG. 6 is a flowchart of a method for emulating a read command; and

FIG. 7 is a flow diagram for emulating a read command.

### DETAILED DESCRIPTION

A method for emulating a command for communication with an input/output (I/O) port includes receiving the command from a host and redirecting the command to a microcontroller, which emulates the command by communicating with the I/O port. In one implementation, the hardware section emulates the command by implementing a transaction with the I/O port via a microcontroller over an interconnect, such as the SMBus, and is used in conjunction with a power management standard, such as the ACPI specification. It is noted that this implementation is one example, and that a person skilled in the art may implement the methods and systems described herein using other interconnects and other power management standards.

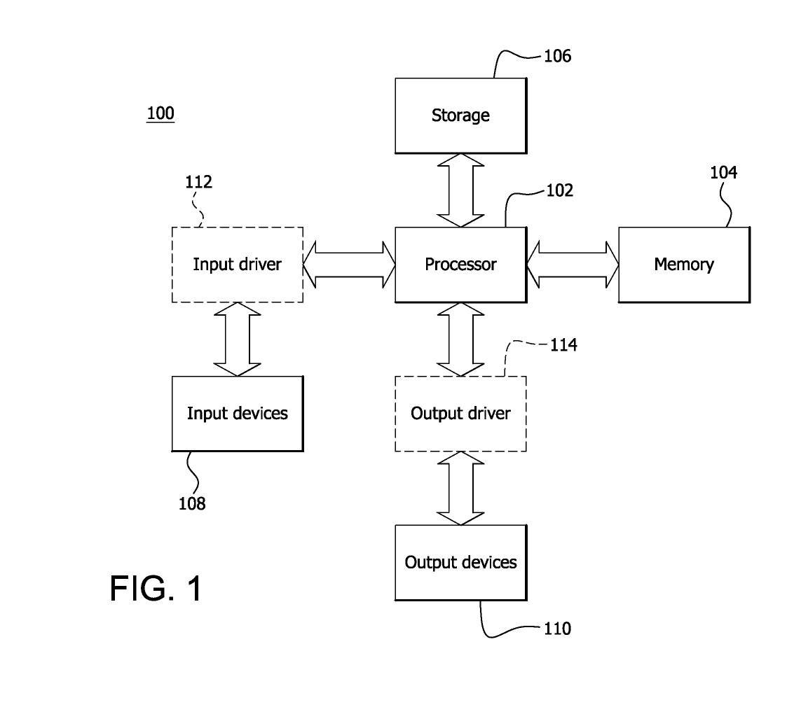

FIG. 1 is a block diagram of an example device 100 in which one or more disclosed embodiments of a general purpose computer system may be implemented. The device 100 or the general purpose computer system may include, for example, a desktop computer, a server computer, a laptop computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU), a graphics processing unit (GPU), a CPU and GPU located on the same die, or one or more processor cores, wherein each processor core may be a CPU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

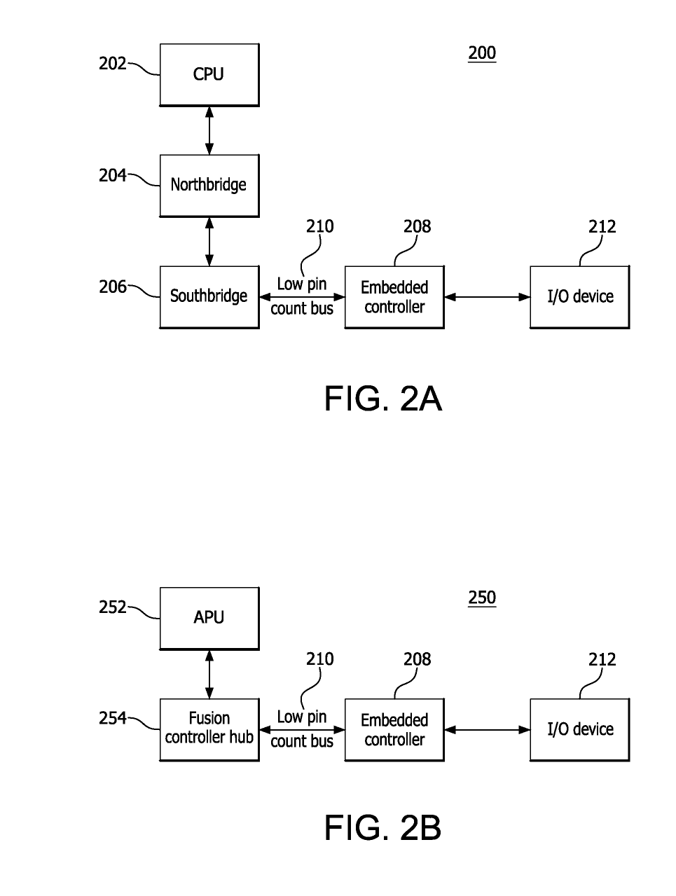

FIG. 2A is a block diagram of a CPU-based system 200 using an LPC bus. The system 200 includes a CPU 202 in communication with a northbridge (memory controller) 204, which is in communication with a southbridge (I/O controller hub) 206. The southbridge 206 is in communication with an embedded controller 208 via an LPC bus 210. The embedded controller 208 is in communication with an I/O device 212.

FIG. 2B is a block diagram of an APU-based system 250 using an LPC bus. The system 250 includes an APU 252 in communication with a Fusion controller hub 254. The Fusion controller hub 254 communicates with an embedded controller 208 via an LPC bus 210. The embedded controller 208 is in communication with an I/O device 212.

The ACPI specification for interfacing an EC to a host specifically calls for an I/O mapped set of registers: EC Command/Status Register and EC Data Register. In addition, a scan matrix keyboard may be connected to the EC and an interface between the KBC and the host is also mapped into I/O space using a KBC Command/Status Register and a KBC Data Register. Typically, the EC and KBC interfaces use the following I/O ports: EC Command/Status Register at I/O port 66, EC Data Register at I/O port 62, KBC Command/Status Register at I/O port 64, and KBC Data Register at I/O port 60. It is noted that these port assignments are exemplary, and may be changed without altering the operation of the embodiments described herein.

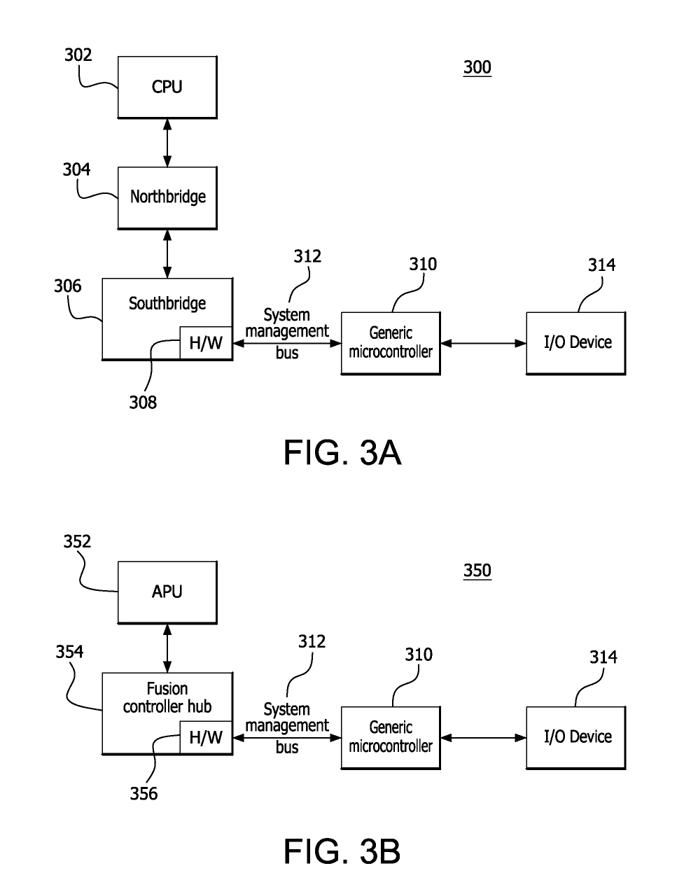

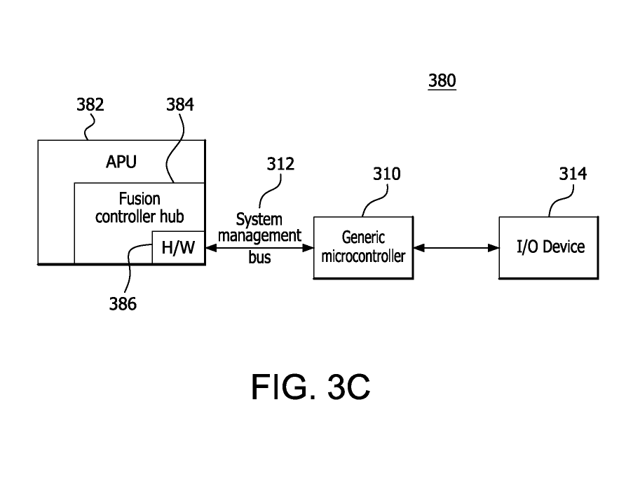

FIG. 3A is a block diagram of a CPU-based general purpose computer system 300 using an SMBus. The system 300 includes a CPU 302 in communication with a northbridge 304, which is in communication with a southbridge 306, which includes a special hardware section 308 (described below). The hardware section 308 is in communication with a generic microcontroller 310 via a SMBus 312. The generic microcontroller 310 is in communication with an I/O device 314.

FIG. 3B is a block diagram of an APU-based general purpose computer system 350 using an SMBus. The system 350 includes an APU 352 in communication with a Fusion controller hub 354, which includes a special hardware section 356 (described below). The hardware section 356 communicates with a generic microcontroller 310 via a SMBus 312. The generic microcontroller 310 is in communication with an I/O device 314.

FIG. 3C is a block diagram of an alternate APU-based general purpose computer system 380 using a SMBus. The system 380 includes an APU 382 including a Fusion controller hub 384, which includes a special hardware section 386 (described below). The hardware section 386 communicates with a generic microcontroller 310 via a SMBus 312. The generic microcontroller 310 is in communication with an I/O device 314.

To use the generic microcontroller 310, the I/O accesses to the EC and KBC ports can be trapped via the hardware section 308, 356, 386. The hardware section 308, 356, 386 then converts those accesses to a pre-defined set of SMBus transactions. In this way, older software, such as the BIOS or the OS, may still interface with the generic microcontroller 310 without modifying the base software.

The hardware section 308, 356, 386 for trapping the I/O transaction may be implemented in several ways. For example, the I/O transaction may be trapped by a legacy block in the FCH/SB that looks for an I/O read or write to a designated port, and then redirects the transaction to a hardware state machine that converts the I/O transaction into a series of SMBus transactions, as described below. The legacy block supports the “original” IBM PC peripherals such as a Direct Memory Access (DMA) controller, a programmable interrupt controller (PIC), etc. Most I/O transactions with an address below 0x3FF are routed to the legacy block in the FCH/SB. If the I/O device being addressed exists in the FCH/SB, that I/O device will respond. If the I/O device being addressed does not exist in the FCH/SB, the legacy block sends the I/O transaction on the LPC bus, with the expectation that the I/O device being addressed is somewhere on the LPC bus. In the example described herein, I/O addresses port 62 and port 66 are sent out on the SMBus and not on the LPC bus.

Another example hardware implementation for trapping the I/O transaction is to redirect the I/O port to a microcontroller in the FCH/SB. The firmware in the microcontroller then generates the series of SMBus transactions.

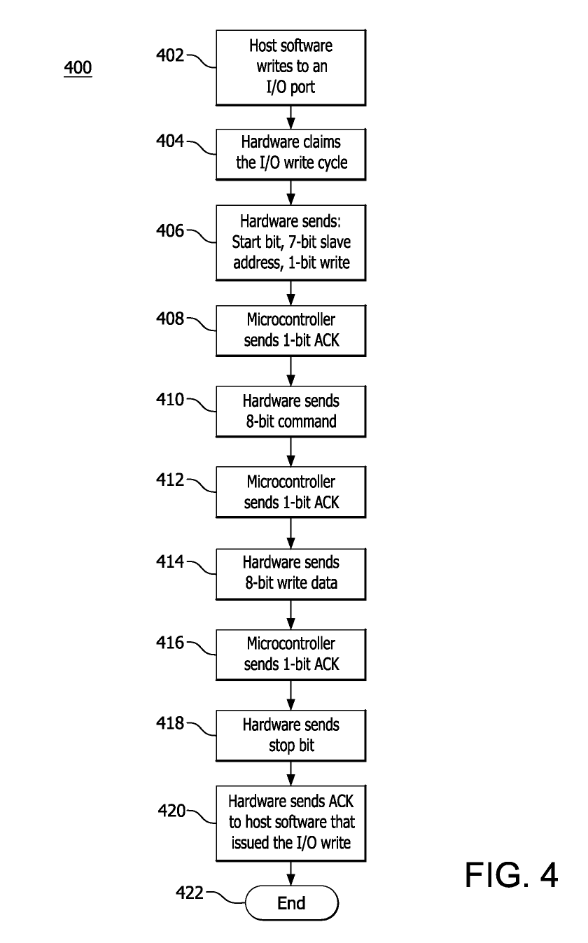

FIG. 4 is a flowchart of a method 400 for emulating a write command to one of the I/O ports (e.g., I/O ports 62 or 66). It is noted that the method 400 operates in the manner same regardless of which port is being written to. The host software writes to an I/O port (step 402). The hardware in the FCH/SB (referred to hereinafter as “hardware”), depending on the system configuration, claims the I/O write cycle (step 404). The I/O write cycle is claimed by the hardware through programming on various bridges in the APU or CPU. It is noted that the hardware is embedded in the FCH/SB, and the FCH/SB may be located as shown in any of FIGS. 3A-3C. The following transaction is performed on the SMBus associated with the I/O port.

The hardware sends a start bit, a 7-bit SMBus slave address (the address of the microcontroller), and a 1-bit write to the microcontroller (step 406). The microcontroller responds to receiving the start bit, the address, and the write bit by sending a 1-bit acknowledgement (ACK) to the hardware (step 408). The hardware then sends an 8-bit command to the microcontroller (step 410).

The 8-bit command that is sent to the microcontroller depends upon which port is to be accessed and whether the host software is writing to the port or reading from the port; the command values are shown in Table 1. It is noted that these commands are exemplary, and that a person skilled in the art could derive other, similar commands to achieve the same result without modifying the operation of the method 400.

TABLE 1
List of 8-bit command values

| Bit value | Command |
|---|---|
| 0x0 | EC Command Register Write |
| 0x1 | EC Status Register Read |
| 0x2 | EC Data Register Write |
| 0x3 | EC Data Register Read |
| 0x4 | KBC Command Register Write |
| 0x5 | KBC Status Register Read |
| 0x6 | KBC Data Register Write |
| 0x7 | KBC Data Register Read |

Firmware running on the microcontroller would need to understand the command set and the firmware services the commands according to, for example, the EC behavior documented in Chapter 12 of the ACPI specification, Version 5.

The microcontroller responds to receiving the command by sending a 1-bit ACK to the hardware (step 412). The hardware then sends an 8-bit write data to the I/O port (step 414). The microcontroller sends a 1-bit ACK for the data received to the hardware (step 416). After the write data has been transmitted, the hardware sends a stop bit to the microcontroller (step 418). Optionally (if required), the hardware sends an ACK (e.g., Target Done) back to the host software that issued the I/O port write (step 420), and the method terminates (step 422).

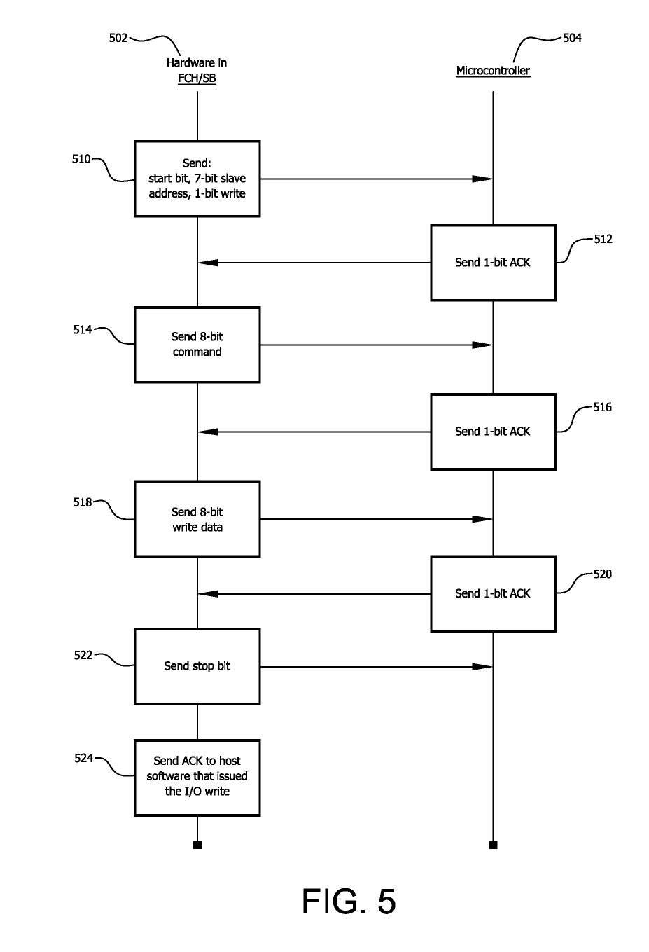

FIG. 5 is a flow diagram for emulating a write command to one of the I/O ports, between hardware in a FCH/SB 502 and a microcontroller 504. The hardware 502 sends a start bit, a 7-bit slave address (the address of the microcontroller 504), and a 1-bit write to the microcontroller 504 (step 510). The microcontroller 504 responds to receiving the start bit, the address, and the write bit by sending a 1-bit ACK to the hardware 502 (step 512). The hardware 502 then sends an 8-bit command to the microcontroller 504 (step 514). The 8-bit command sent to the microcontroller 504 is one of the commands listed in Table 1 above.

The microcontroller 504 responds to receiving the command by sending a 1-bit ACK to the hardware 502 (step 516). The hardware 502 then sends an 8-bit write data to the I/O port (step 518). The microcontroller 504 sends a 1-bit ACK for the data received to the hardware 502 (step 520). After the write data has been transmitted, the hardware 502 sends a stop bit to the microcontroller 504 (step 522). Optionally (if required), the hardware 502 sends an ACK (e.g., Target Done) back to the host software that issued the I/O port write (step 524).

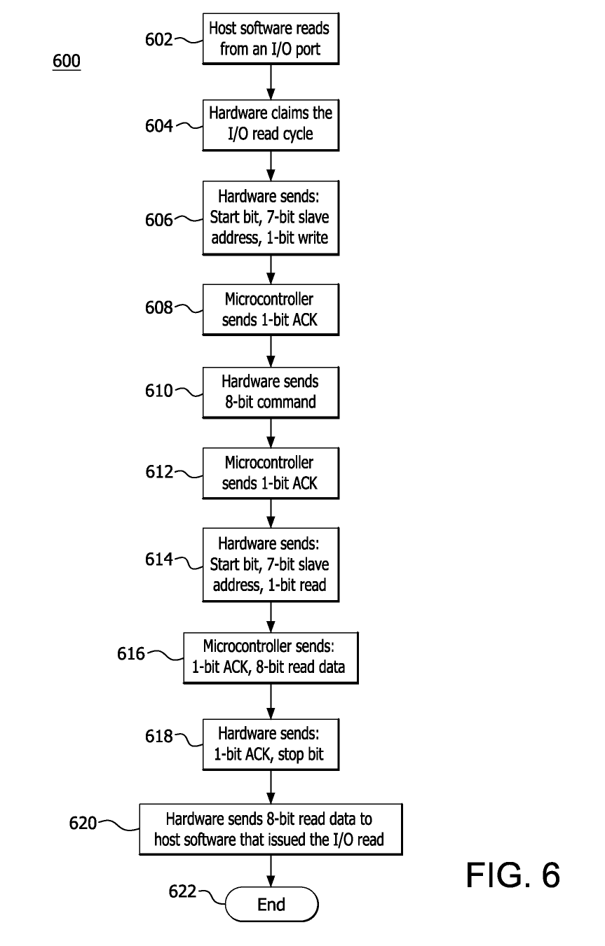

FIG. 6 is a flowchart of a method 600 for emulating a read command from one of the I/O ports (e.g., I/O ports 62 or 66). It is noted that the method 600 operates in the same manner regardless of which port is being read from. The host software reads from an I/O port (step 602). The hardware in the FCH/SB, depending on the system configuration, claims the I/O read cycle (step 604). The I/O read cycle is claimed by the hardware through programming on various bridges in the APU or CPU. It is noted that the hardware is embedded in the FCH/SB, and the FCH/SB may be located as shown in any of FIGS. 3A-3C. The following transaction is performed on the SMBus associated with the I/O port.

The hardware sends a start bit, a 7-bit slave address (address of the microcontroller), and a 1-bit write to the microcontroller (step 606). The microcontroller responds to receiving the start bit, the address, and the write bit by sending a 1-bit ACK to the hardware (step 608). The hardware then sends an 8-bit command to the microcontroller (step 610). The 8-bit command sent to the microcontroller is one of the commands listed in Table 1 above.

The microcontroller responds to receiving the command by sending a 1-bit ACK to the hardware (step 612). The hardware then sends a start bit, a 7-bit slave address, and a 1-bit read to the microcontroller (step 614). The microcontroller sends a 1-bit ACK for receiving the start bit, the address, and the read bit and sends an 8-bit read data from the I/O port to the hardware (step 616). The hardware sends a 1-bit ACK for the read data and a stop bit to the microcontroller (step 618). The hardware then sends the read data to the host software that issued the read command (step 620) and the method terminates (step 622).

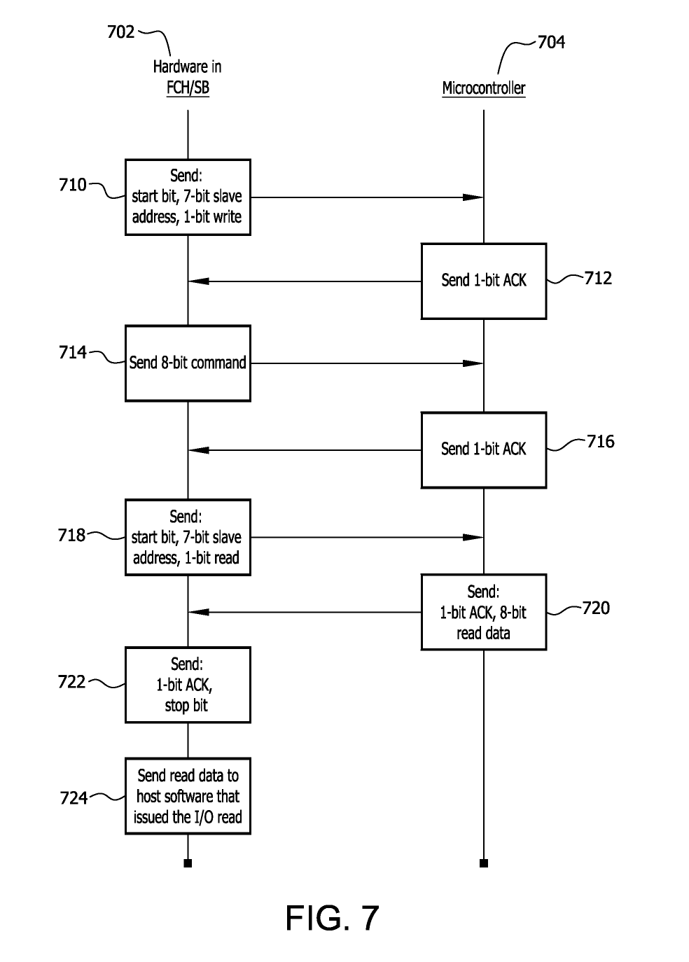

FIG. 7 is a flow diagram for emulating a read command from one of the I/O ports, between hardware in a FCH/SB 702 and a microcontroller 704. The hardware 702 sends a start bit, a 7-bit slave address (the address of the microcontroller 704), and a 1-bit write to the microcontroller 704 (step 710). The microcontroller 704 responds to receiving the start bit, the address, and the write bit by sending a 1-bit ACK to the hardware 702 (step 712). The hardware 702 then sends an 8-bit command to the microcontroller 704 (step 714). The 8-bit command sent to the microcontroller 704 is one of the commands listed in Table 1 above.

The microcontroller 704 responds to receiving the command by sending a 1-bit ACK to the hardware 702 (step 716). The hardware 702 then sends a start bit, a 7-bit slave address, and a 1-bit read to the microcontroller 704 (step 718). The microcontroller 704 sends a 1-bit ACK for receiving the address and the read bit and sends an 8-bit read data from the I/O port to the hardware 702 (step 720). The hardware 702 sends a 1-bit ACK for the read data and a stop bit to the microcontroller 704 (step 722). The hardware then sends the read data to the host software that issued the read command (step 724).

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the present invention.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for emulating a command for communication with an input/output (I/O) port, comprising:
receiving the command from a host; and
redirecting the command to a microcontroller, whereby the microcontroller emulates the command by communicating with the I/O port.

2. The method according to claim 1, wherein the redirecting includes:
initiating a transaction with the microcontroller on a communication bus;
receiving a first acknowledgement (ACK) from the microcontroller, for receiving the initiation;
sending an argument of the command to the microcontroller on the communication bus;
receiving a second ACK from the microcontroller, for receiving the argument; and
sending a stop indication to the microcontroller on the communication bus.

3. The method according to claim 2, wherein the transaction includes:
a start indication;
an address of the microcontroller;
a write indication; and
the command.

4. The method according to claim 2, wherein:
the command is a write command; and
the argument includes data to be written to the I/O port.

5. The method according to claim 4, further comprising:
sending an ACK to the host that issued the command.

6. The method according to claim 2, wherein:
the command is a read command; and
the argument includes:
an address of the microcontroller; and
a read indication.

7. The method according to claim 6, further comprising:
receiving read data from the microcontroller;
sending an ACK to the microcontroller for the read data; and
sending the read data to the host that issued the command.

8. The method according to claim 1, further comprising:
trapping the command, wherein the trapping includes claiming the I/O cycle.

9. A system for emulating a command sent by a host for communication with an input/output (I/O) port, comprising:
a processor;
a microcontroller; and
a controller in communication with the processor and the microcontroller, the controller configured to redirect the command, whereby the controller emulates the command by communicating with the I/O port via the microcontroller.

10. The system according to claim 9, wherein the controller and the microcontroller communicate via a System Management Bus (SMBus).

11. The system according to claim 9, wherein the controller is further configured to trap the command.

12. The system according to claim 9, wherein the controller is further configured to:
initiate a transaction with the microcontroller on a communication bus;
receive a first acknowledgement (ACK) from the microcontroller, for receiving the initiation;
send an argument of the command to the microcontroller on the communication bus;
receive a second ACK from the microcontroller, for receiving the argument; and
send a stop indication to the microcontroller on the communication bus.

13. The system according to claim 12, wherein the transaction includes:
a start indication;
an address of the microcontroller;
a write indication; and
the command.

14. The system according to claim 12, wherein:
the command is a write command;
the argument includes data to be written to the I/O port; and
the controller is further configured to send an ACK to the host that issued the command.

15. The system according to claim 12, wherein:
the command is a read command;
the argument includes:
an address of the microcontroller; and
a read indication; and
the controller is further configured to:
receive read data from the microcontroller;
send an ACK to the microcontroller for the read data; and
send the read data to the host that issued the command.

16. The system according to claim 9, wherein:
the processor is a central processing unit; and
the controller is a southbridge.

17. The system according to claim 9, wherein:
the processor is an accelerated processing unit; and
the controller is a Fusion controller hub.

18. The system according to claim 17, wherein the Fusion controller hub is part of the accelerated processing unit.

19. A non-transitory computer-readable storage medium storing a representation of a circuit, the computer-readable representation comprising logic to emulate a command sent by a host for communication with an input/output (I/O) port, the logic comprising:
a receiving code segment for receiving the command from the host; and
a redirecting code segment for redirecting the command to a microcontroller, whereby the microcontroller emulates the command by communicating with the I/O port.

20. The computer-readable storage medium of claim 19, wherein the logic includes hardware description language (HDL) instructions used for the manufacture of a device.

21. A hardware section for emulating a command for communication with an input/output (I/O) port, the hardware section configured to:
receive the command from a host; and
redirect the command, whereby the hardware section emulates the command by communicating with the I/O port via a microcontroller.

22. The hardware section according to claim 21, wherein the hardware section is further configured to trap the command by claiming the I/O cycle.

23. The hardware section according to claim 21, wherein the hardware section is further configured to redirect the command by:
initiating a transaction with the microcontroller on a communication bus;
receiving a first acknowledgement (ACK) from the microcontroller, for receiving the initiation;
sending an argument of the command to the microcontroller on the communication bus;
receiving a second ACK from the microcontroller, for receiving the argument; and
sending a stop indication to the microcontroller on the communication bus.
